(19) United States
(12) Patent Application Publication
(10) Pub. No.: US 2020/0370965 A1
(43) Pub. Date: Nov. 26, 2020

(54) Thermopile Assembly Providing a Massive Electrical Series of Thermocouple Elements

(71) Applicant: Arthur Beckman, Washington, DC (US)

(72) Inventor: Arthur Beckman, Washington, DC (US)

(21) Appl. No.: 16/288,081

(22) Filed: Feb. 27, 2019

Related U.S. Application Data
(60) Provisional application No. 62/636,253, filed on Feb. 28, 2018.
(60) Provisional application No. 62/646,582, filed on Mar. 22, 2018.
(60) Provisional application No. 62/767,720, filed on Nov. 15, 2018.
(60) Provisional application No. 62/805,285, filed on Feb. 13, 2019.

(51) Int. Cl. G01K 7/04; G01K 7/02

(52) U.S. Cl. CPC G01K 7/04; G01K 1/12; G01K 7/026

(57) ABSTRACT

Devices and methods are provided for the low-cost manufacturing of thermoelectric power-generation devices (thermopiles) using stable, common materials that can function at very high temperatures. An improved geometry for thermocouple elements in the assembly provides for incorporating a large number of thermocouples. The geometry includes holes and cross-channels in an electrically-insulative device body comprising a material such as a ceramic or glass whereby thermocouple material may be deposited and the device heated to sinter or melt the deposited thermocouple material to form a thermopile. Also provided is a thermopile assembly wherein substrates formed by 3D printing or otherwise are stacked to create the thermopile. These device geometries and manufacturing procedures enable the low-cost production of thermopiles comprised of a massive number of thermocouple elements, from hundreds to hundreds of thousands or more, for electrical power generation using common, standard metallic thermocouple materials and common, widely used electrical insulation materials.

### RELATED APPLICATIONS

The present application claims benefit to U.S. provisional applications Ser. No. 62/636,253 entitled “3D-Printed Stacked Thermopile Providing Massive Electrical Series Assembly of Thermocouple Elements” and filed Feb. 28, 2018, Ser. No. 62/646,582 entitled “Thermopile Assembly Providing a Massive Electrical Series of Thermocouple Elements” and filed Mar. 22, 2018, Ser. No. 62/767,720, entitled “Thermopile Assembly Providing a Massive Electrical Series of Thermocouple Elements” and filed Nov. 15, 2018 and Ser. No. 62/805,285 entitled “Thermopile Assembly Providing a Massive Electrical Series of Wire Thermocouple Element” and filed Feb. 13, 2019, which are all incorporated by reference herein.

### FIELD OF THE INVENTION

This generally relates to thermopiles which generate electricity from heat.

### BACKGROUND

In thermoelectric power generation, electricity is generated from heat. To do so, a thermocouple produces an electromotive force (“EMF,” more commonly called a “voltage”) when there is a temperature difference between the (hot) “measuring” junction of the thermocouple and the (cold) “reference” junction of the thermocouple. Thermopiles are arrangements of thermocouples in an electrical series. The series arrangement provides for the voltages generated by each thermocouple to be additive, as a voltage equal to the number of hot junctions multiplied by the EMF of each thermocouple is produced. Accordingly, thermopiles have been used to generate electric power in certain applications, notably in spacecraft. Unfortunately, the power generated by standard thermocouples is generally small and in the low millivolt range.

Numerous conventional designs for thermopiles and thermoelectric power-generation devices are known. Many of these designs employ material formulations that produce a relatively strong thermoelectric effect. The goals in developing many of these designs and materials have often been to optimize and maximize EMF and efficiency in converting heat into electricity by way of the thermoelectric materials themselves. These conventional designs, however, often sacrifice cost effectiveness and practicality in the interest of producing maximum power-generation efficiency by way of the chemical and microstructural properties of the materials used. The materials used in these technologies are, additionally, often scarce, toxic and/or less-robust, stable, and resilient than more commonly used thermocouple materials such as iron, copper, nickel-chromium, nickel-aluminum alloys, and other common materials such as Nichrome, Monel, and nickel that produce a thermoelectric effect. Additionally, many innovative, high-efficiency materials such as bismuth telluride, lead telluride, and tetrahedrites are not usable at elevated temperatures at which standard thermocouple materials will perform adequately.

Accordingly, it is desirable to have an assembly and process that is cost efficient and avoids these and other related problems.

### SUMMARY

In accordance with an embodiment, a thermopile is provided including a series of thermocouples, comprising a heat-resistant, electrically-insulative container, comprising a first hole configured to receive an electrically-positive thermocouple material. The container further comprises a second hole configured to receive an electrically-negative thermocouple material parallel to the first hole, and a cross-channel connecting the first hole and the second hole such that, when the heat-resistant, electrically-insulative container is heated with the electrically-positive thermocouple material deposited in the first hole and the electrically-negative thermocouple material deposited in the second hole, the cross-channel forms a hot junction in a thermocouple element formed by the electrically-positive thermocouple material and the electrically-negative thermocouple material.

In accordance with another embodiment, a thermopile for withstanding high heat is provided comprising a heat-resistant, electrically-insulative container comprising a plurality of rows of holes configured to receive electrically-positive thermocouple material and electrically-negative thermocouple material. Each row of holes comprises a plurality of pairs of holes, and is connected by a cross-channel to one or more other rows of holes. Each pair of holes is connected to one or more other pair of holes in the same row by a cross-channel. Each hole in the pair of holes connected to each other with an cross-channel, such that when the electrically-positive thermocouple material and the electrically-negative thermocouple material is deposited in the holes and the heat-resistant, electrically-insulative container is heated, the electrically-positive thermocouple material and the electrically-negative thermocouple material form thermocouple elements in the holes, the open cross-channels form hot junctions and cold junctions of the thermocouple elements, and the thermocouple elements are electrically-serially connected throughout the heat-resistant, electrically-insulative container to form the thermopile.

In yet another embodiment, a method of creating a heat-resistant thermopile is provided, comprising depositing an electrically-positive thermocouple material into a first set of holes in a heat-resistant, electrically-insulative container that contains cross-channels to a second set of holes parallel to the first set of holes, and depositing an electrically-negative thermocouple material into the second set of holes in the heat-resistant, electrically-insulative container. The method further comprises heating the heat-resistant, electrically-insulative container to sinter or melt the electrically-positive thermocouple material and the electrically-negative thermocouple material, wherein the cross-channels form hot junctions and cold junctions of thermocouple elements created by the electrically-positive thermocouple material and the electrically-negative thermocouple material.

In one embodiment, a thermopile assembly is provided having layers of ceramic substrates, comprising a first ceramic substrate and a second ceramic substrate, each having a sheet deposited of electrically-positive thermocouple material and electrically-negative thermocouple material to form a row of thermocouple elements, and an electrically-insulative material configured to create a space between the electrically-positive thermocouple material and the electrically-negative thermocouple material. The thermopile assembly further comprises a third ceramic substrate positioned between the first ceramic substrate and the second ceramic substrate and having a hole permitting contact between the thermocouple elements in the first and second ceramic substrates to form an electric series.

### BRIEF DESCRIPTION OF THE DRAWINGS

FIG. 1 illustrates a frontal cross-section of an embodiment a thermopile device with thermocouple materials deposited in cavities.

FIG. 2A illustrates a three-dimensional view of the thermopile device shown in FIG. 1.

FIG. 2B illustrates a reverse angle of the three-dimensional view of the thermopile device shown in FIG. 2A.

FIG. 3 provides a supplemental, oblique cross-sectional view of holes and cross-channels formed in the body of the thermopile device and connection notches in which thermocouple junctions are formed on the top of the device.

FIG. 4 shows a stencil used in fabrication of the thermopile device.

FIG. 5 shows a fabrication method of the device body using pastes comprised of thermocouple materials to seal through-hole openings on the bottom.

FIG. 6 shows another fabrication method wherein three separate electrically-insulative components are combined to form the device body.

FIG. 7 shows the use of electrically-insulative materials of differing thermal conductivities to fabricate the device body to enhance the thermal gradient between the hot and cold junctions of the device.

FIG. 8A illustrates 3 intermediary layers of the thermocouple elements and the electrically-insulative device body 3D-printed simultaneously.

FIG. 8B illustrates 2 additional layers of the thermocouple elements and the electrically-insulative device body 3D-printed simultaneously.

FIG. 8C illustrates the top and bottom layers of the thermocouple elements and the electrically-insulative device body 3D-printed simultaneously.

FIG. 9 illustrates the arrangement of the thermocouple elements shown in FIG. 8 into a stacked form.

FIGS. 10A and 10B illustrate the printing process indicating the arrangement of thermocouple materials and substrate material on each printed layer, including heat exchanger fins.

FIG. 11 illustrates the arrangement of electrically-insulative material between thermocouple elements (as also shown in FIG. 3) to form external fins providing a heat exchanger function and enabling handling of the device without touching the thermocouple elements.

FIG. 12 illustrates the arrangement of printed thermocouples into ring form and semicircular form both of which can be used to surround pipes and capture waste heat.

FIG. 13 illustrates how thermocouple elements can be arranged in staggered configurations to conform to curved or angled surfaces.

FIG. 14 shows a pre-formed electrically-insulative substrate having pre-formed channels designed to accept thermocouple materials in powder or paste form which will form an array of thermocouples.

FIG. 15 illustrates stencils used to deposit thermocouple materials on the pre-formed electrically-insulative substrates or in the pre-formed channels depicted in FIG. 14.

FIG. 16 depicts a terminal into which subassemblies, also depicted in FIG. 16, containing thermocouples in electrical series, are assembled into a larger electrical series.

FIG. 17 depicts an electrically-insulative body having preformed through-holes, into which thermocouple materials, in powder or paste form, are deposited, producing the positive and negative legs of individual thermocouple elements.

FIG. 18 depicts stencils which guide the junction-forming pastes into the proper places in the embodiment depicted in FIG. 17.

FIG. 19 illustrates a flowchart of a method for creating a thermopile.

FIG. 20 is a flowchart of a method for simultaneously printing the thermocouple and ceramic materials.

### DETAILED DESCRIPTION

Methods and devices in accordance with the present invention provide for low-cost manufacturing of thermoelectric power-generation devices using stable, common materials that can function at temperatures as high as 1,000° C. (1,832° F.), and beyond. They do so with an improved geometry for thermocouple elements in the assembly. These assemblies provide for incorporating a very large number of thermocouples into a device which can therefore produce power levels usable in practical applications such as lighting, heating, cooling, running equipment, or selling the electricity to an electric utility company, for example. This geometry includes holes and cross-channels in an electrically-insulative ceramic, for example, whereby thermocouple material may be deposited and the device heated to sinter the deposited thermocouple material in place to form a thermopile.

These methods and devices also provide an improved thermopile assembly wherein substrates are stacked to create the thermopile. For example, the thermopile may be formed by 3D printing layers of thermocouple material with electrically-insulative material such as glass or ceramic, with the substrates stacked together to form a thermopile.

These device geometries and manufacturing procedures enable the low-cost production of thermopiles comprised of a massive number of thermocouple elements, from hundreds to hundreds of thousands or more, for electrical power generation using common, standard metallic thermocouple materials and common, widely used electrical insulation materials. The device can additionally employ a wide variety of metals that are not standard thermocouple materials but that nonetheless produce a thermoelectric effect. These thermopile devices can later be assembled into a series of devices further producing a cumulative power-generation effect.

These devices provide an economical and practical means of capturing waste heat thrown off by industrial processes, power generation, and waste disposal, for example, and using that heat to produce electric power by way of thermoelectric effects. The devices additionally provide a reliable primary way of generating electricity from heat produced by solar, nuclear, geothermal, fossil fuel, or biomass sources and a primary way of generating electricity by way of other naturally occurring or intentionally produced processes that produce thermal gradients. The devices are designed to be able to operate durably and reliably at temperatures greater than 300° C./672° F., up to 1000° C./1,832° F., and in some cases, even higher.

Several advantages are provided. First, as noted above, common, low-cost materials can be used which are durable, stable, and relatively low in toxicity, and which can be used at relatively high temperatures and in somewhat hostile environments—unlike many novel thermoelectric material formulations that have conventionally been developed to maximize thermoelectric power-generation efficiency.

Second, the configuration of the device, which can incorporate hundreds, thousands, and potentially hundreds of thousands of thermocouple elements or more into a thermopile configuration, provides thermoelectric power-generation efficiency due to the large number of thermocouples that can be formed within the device. “Additive” manufacturing (3-D printing) methods such as (but not limited to) stereolithography, binder jetting, material jetting, selective laser sintering, and powder-bed fusion, are particularly well-suited to fabricating the electrically-insulative body of the device which provides its overall structure and cavities into which thermocouple materials, in powder or paste form, are deposited and later sintered or melted into place. Additive manufacturing providing for the printing and sintering of multiple materials may additionally be used to print the entire device, including the thermocouple-material components. Other, more conventional methods of forming the electrically-insulative body can, of course be employed, including extrusion, casting, injection molding, machining, or the assembly of multiple electrically insulative components. Additionally, the materials making up the thermocouple elements can be deposited into the device or onto substrates comprising the device using vacuum deposition, sputtering, flame-spraying, and screen printing.

Third, the designs allow for relatively inefficient, but economical and stable materials to be arranged in a manner that provides a practical and economically attractive thermoelectric power-generation solution which is particularly well-suited to waste-heat recovery applications, but which can also be used in primary power generation applications noted above, for example. More thermoelectrically-efficient but often costly and less resilient thermocouple materials such as bismuth telluride, silicon germanium, lead telluride, tetrahedrites, and others can be used, as well as the standard and non-standard thermocouple material combinations noted above. For example, the design allows for many types of materials having thermoelectric effects, including highly efficient but comparatively novel materials that may be costly or fragile, and more common and less thermoelectrically efficient but highly resilient materials such as iron, nickel, copper, Nichrome, Monel, and standard thermocouple materials such as Chromel, Alumel, and Constantan, to be arranged in a manner that provides relatively large aggregate thermoelectric effects when placed in a massive electrical-series arrangement.

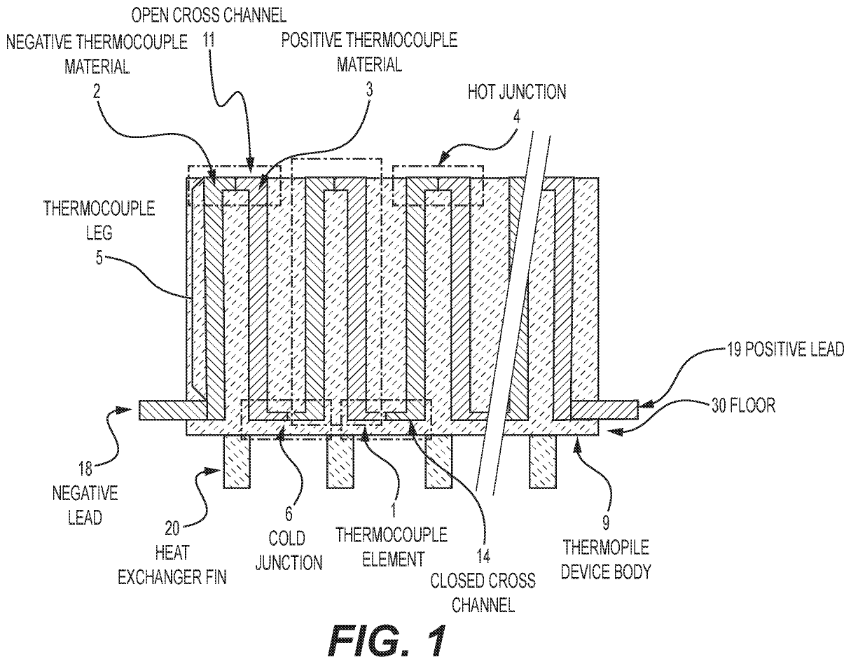

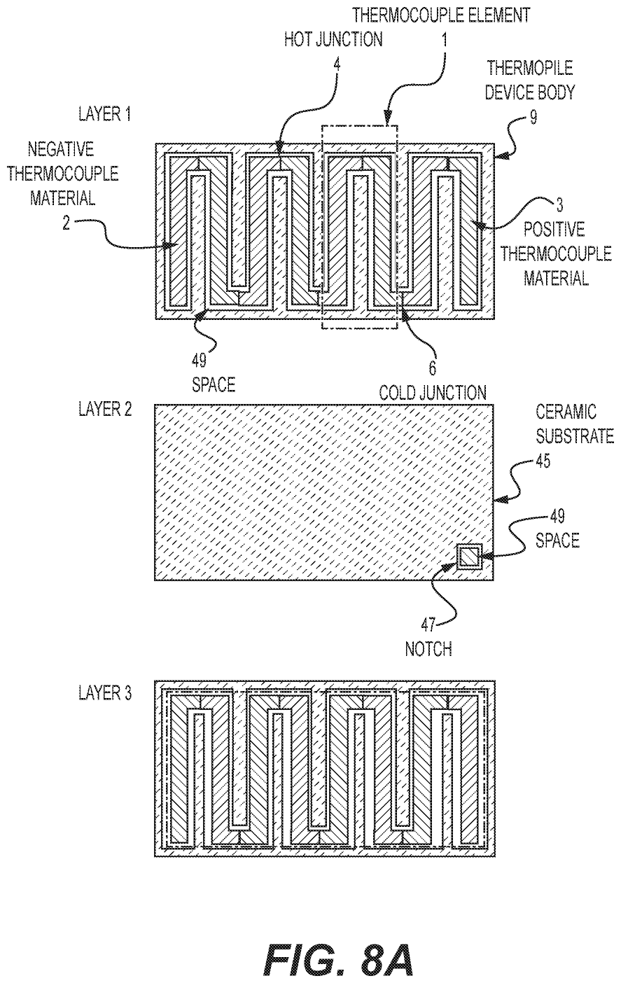

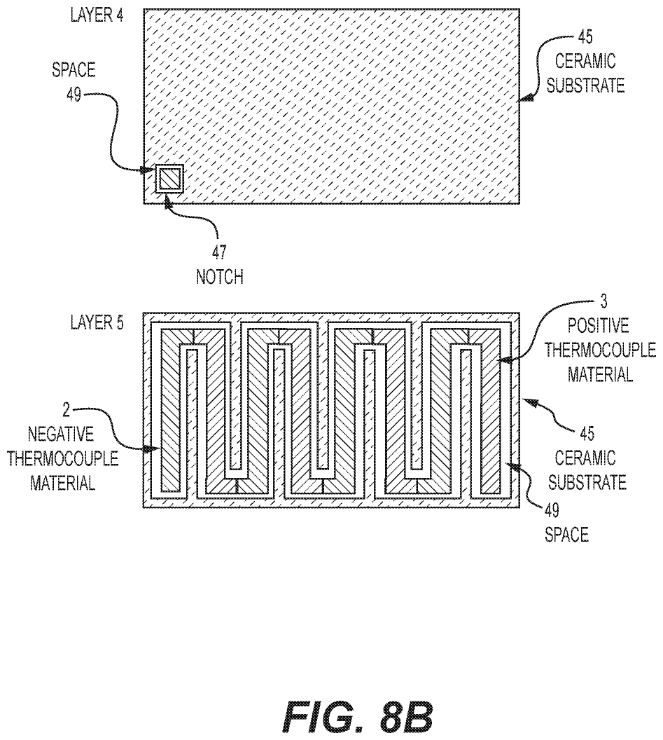

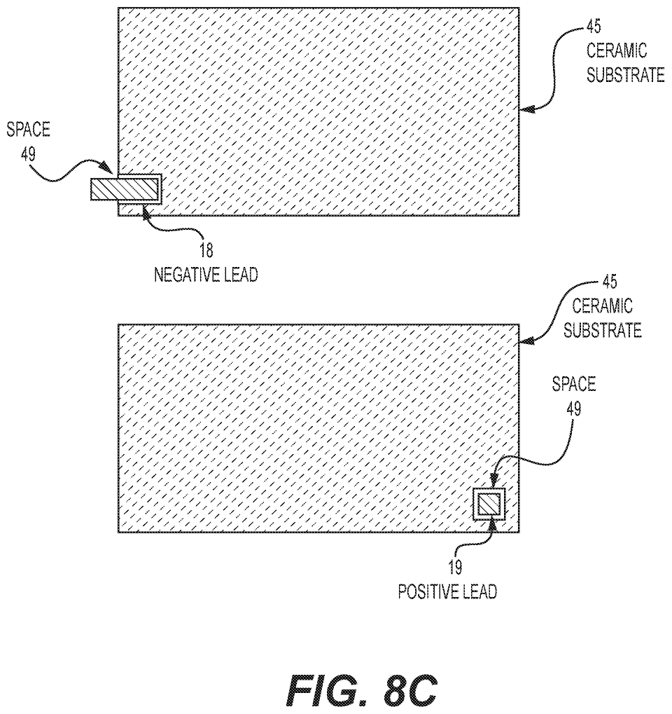

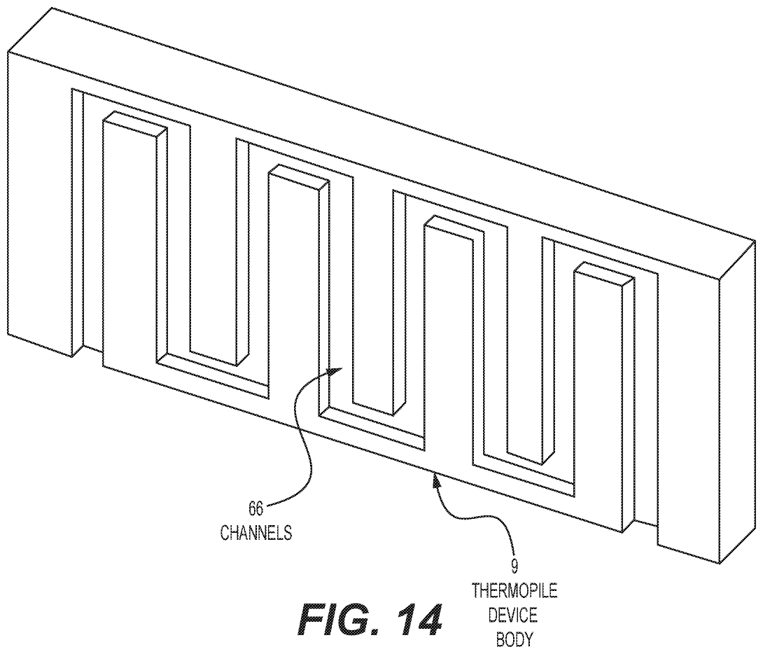

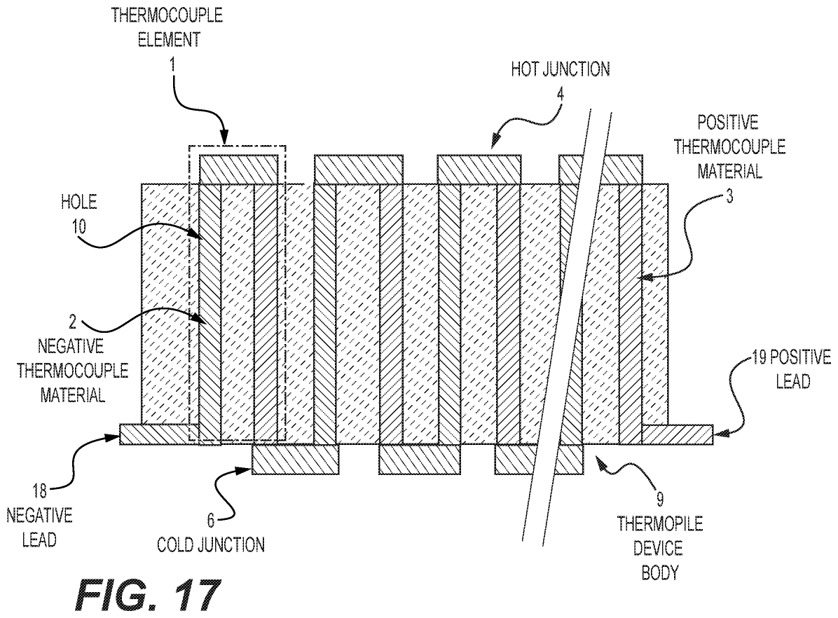

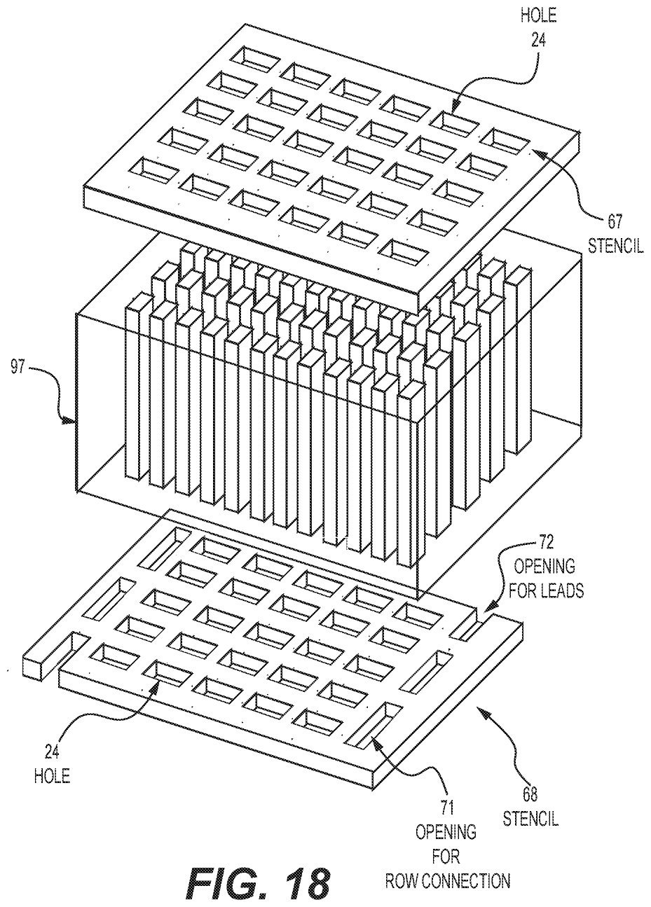

Four general embodiments are described below, however, many more are possible. These are listed as Embodiments A-D. FIGS. 1-7 and 19 describe Embodiment A, FIGS. 8-13 and 20 describe Embodiment B, and FIGS. 14-16 describe Embodiment C, and FIGS. 17-18 described Embodiment D.

In Embodiment A, the process involves pre-forming a body of ceramic or other electrically-insulative material within which are preferentially formed cavities and channels into which thermocouple materials in powdered or paste form are deposited and then sintered or melted, forming thermoelements of highly integrated metallic structure. Provision is made in this embodiment for cross-channels in the body of the device that join pairs of thermocouple legs when thermocouple metals are deposited in them. These channels may be rectangular, cylindrical, or any other shape. This embodiment is described with respect to FIGS. 1-7 and 19.

The Embodiment B process is achieved by printing the body of the device, using three-dimensional printing technology or other solid-material printing technologies, while simultaneously printing the thermocouple materials therein. This embodiment is described with respect to FIGS. 8-13 and 20.

In Embodiment C, thermocouple metals are printed or deposited, in powder or paste form, onto or into pre-formed electrically-insulative substrates that are either flat or that have channels formed in them for receiving the metallic thermocouple materials, which are later sintered or melted. The metals are deposited in a manner that produces a large number of thermocouples in electrical series on each substrate, each of which comprises a subassembly of the device. These substrates are then inserted into a prefabricated terminal that connects the subassemblies in electrical series. This embodiment is described with respect to FIGS. 14-16.

Embodiment D is achieved by depositing thermocouple metals, in powder or paste form, into an electrically-insulative body having preformed through-holes, producing legs of individual thermocouples, and then forming thermocouple junctions on the top and bottom of the electrically-insulative body by depositing thermocouple metal in paste form in a manner that joins the thermocouple legs at the openings of the through-holes, thus forming thermocouple junctions, without the use of cross-channels, formed in the device body, described in the descriptions of the first embodiment. The powder or paste-form metals are later sintered in a controlled atmosphere to form highly integrated metallic components. Additionally, the through-holes in the device body in this embodiment may be rectangular, cylindrical, or any other shape. This embodiment is described with respect to FIGS. 17-18.

### Embodiment A

FIG. 1 illustrates a frontal cross-section of Embodiment A of the thermopile device 7 with thermocouple materials deposited in cavities. It illustrates the basic scheme of construction and the manner in which the thermocouple materials are deposited into holes and cross-channels of the body of the thermopile device 7 which is made of an electrically-insulative material such as a ceramic or glass. The thermopile device 7 includes an individual thermocouple element 1 (shown circled on the figure) made of materials, in powder, paste, wire, or metal fragment form, comprising an electrically-negative leg of the element comprising a negative thermocouple material 2 and an electrically-positive leg of the element comprising a positive thermocouple material 3. In one embodiment, these positive and negative elements are repeatedly snaked throughout the thermopile device in a repeating elongated U-shaped and snaking fashion shown on FIG. 1. A thermocouple leg 5 is one length of the area of one type of thermocouple material, either positive or negative. The electrically-positive and electrically-negative thermocouple materials 2, 3 may be selected by the types of materials selected, whereas some materials will function as more electrically positive or electrically negative than others.

These thermocouple element materials are later sintered or melted into place at high temperatures in the device in controlled heating conditions such as a vacuum, inert, or reducing atmosphere. Each thermocouple element 1 additionally comprises a hot junction 4, to be situated closest to the heat source, which is formed by sintering, welding, brazing, soldering or otherwise bonding the ends of positive and negative thermocouple legs 5. Each thermocouple element 1 additionally comprises a cold junction 6 situated at a sufficient distance from the heat source to produce a substantial thermal gradient between the hot and cold junctions 4, 6, which is formed by sintering, welding, brazing, soldering or otherwise bonding positive and negative thermocouple legs 5 at the end of each thermocouple element 1 opposite the hot junction.

These cold junctions 6 also provide for electrical series connections of multiple thermocouple elements 1, forming a thermopile. That is, the cold junctions form electrical series connections that electrically connect the thermocouple elements with each other, and as described further below, electrically connect the rows of thermocouple elements with each other.

The hot and cold junctions 4, 6 may be made of the same material as the electrically-positive leg of the thermocouple element 1, or of the same material as the electrically-negative element of the thermocouple element, or of a third electrically conductive material in powder, paste, wire, or metal fragment form.

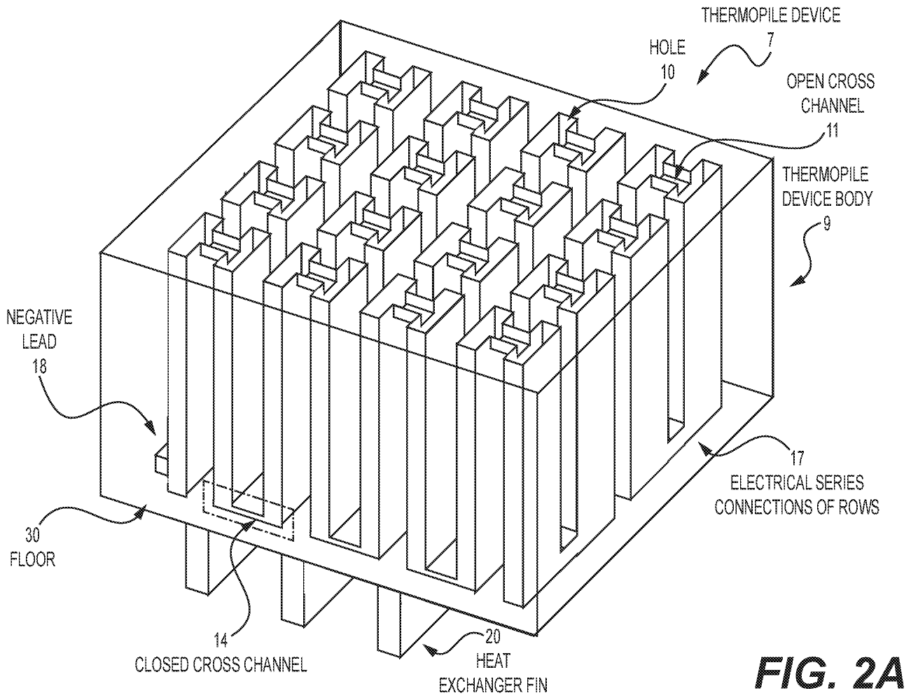

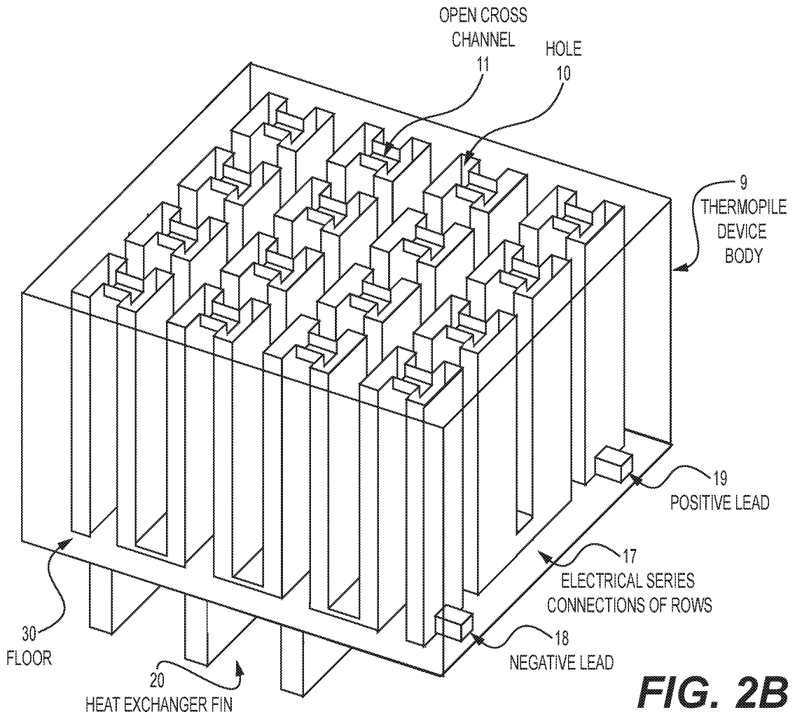

The pre-formed thermopile device body 9 of Embodiment A is made of electrically-insulative material, such as a ceramic or glass which may be fabricated by way of additive manufacturing (e.g., 3D-printing, which may include such methods as stereolithography, binder jetting, material jetting, selective laser sintering, and powder bed fusion). The thermopile device body 9 may also be fabricated by casting, molding, injection molding, machining, or the assembly of multiple electrically-insulative components. This thermopile device body 9 is further shown on FIGS. 2A-2B discussed below.

Outgoing negative lead 18 and positive lead 19 are provided, one at the beginning of the electrical series of thermocouple elements 1 in the thermopile, and one at the end. These negative and positive leads 18 and 19 may be formed by melting or sintering a powder or paste made of a thermocouple material (e.g., positive thermocouple material 2 or negative thermocouple material 3,) or a third electrically conductive material in the open cross-channel 11 and closed cross-channel 14 formed in the thermocouple device 7, or by inserting fully-formed wires, rods, or connectors made of a thermocouple material 2, 3 or a third material at the extremities of the electrical series of thermocouple elements.

The open cross-channel 11 is the open area in the thermocouple device body 9 where positive and negative thermocouple materials 2, 3 meet. It is also the location of the hot junction 4 on FIG. 1. It is a cross-channel because it is a bridge between the legs 5 of the positive and negative thermocouple materials 2, 3 in a given thermocouple element 1, and it is open in this case because there is nothing above it, i.e., there is no ceramic or glass material of the thermocouple body enclosing it on the top. The open cross-channel is also shown on FIG. 2 described below.

Also shown is a closed cross-channel 14. On FIG. 1, this is the open space in the thermopile device body 9 where the positive and negative thermocouple materials meet on the bottom of the thermopile device 7. It is also the location of the cold junction 6 on FIG. 1. It is closed because the thermocouple device body 9 encloses it (and lies below it), and it is not open to the air. The floor 30 of the ceramic or other electrically-insulative material of the thermopile device body 7 seals the closed cross-channels.

External heat exchanger fins 20 providing a heat exchanger function may be formed on the exterior of the thermopile device body 9. These protrusions extend out from the surface of the body 9 of the device, adding surface area, and providing greater exposure of portions of the device on the cold junction side of the device body where all of the cold junctions 6 are located, to air or other heat removal media, for the purpose of enhancing the thermal gradient between the hot and cold thermocouple junctions 4, 6. These heat exchanger fins 20 can also function as protective stand-offs when located on the opposite hot junction side of the device body where the hot junctions are located.

FIG. 2A illustrates a three-dimensional view of the thermopile device 7 of Embodiment A shown in FIG. 1. FIG. 2A shows the arrangement of holes 10 and open and closed cross-channels 11, 14 in the body of the Embodiment A thermopile device 7 into which thermocouple materials will be deposited and fixed into place. As mentioned previously, these cross-channel cavities provide for the formation of hot and cold junctions 4, 6, as well as electrical series connections between thermocouple elements 1 and rows of thermocouple elements, and outgoing leads. These holes 10 are where the positive and negative thermocouple materials 2, 3 are deposited. Holes 10 and open cross-channels 11 are pre-formed in this thermopile device body 9.

These holes 10 may be blind holes (enclosed on one end) or through-holes (open on both ends). In the embodiment in FIG. 2A, the holes 10 are blind holes, whereas they are closed on the bottom. These blind holes 10 are formed and connected by a closed cross-channel 14. One set of blind holes is reserved for negative thermocouple materials while another set of blind holes is reserved for positive thermocouple materials.

The negative and positive thermocouple materials 2, 3 are deposited into the holes 10 to form the legs 5 of the thermocouple elements 1. The negative and positive thermocouple materials 2, 3, or a third electrically conductive material, is deposited in the cross-channels 11, 14 to form the hot and cold thermocouple junctions 4, 6. The formation of the thermocouple cold junctions 6 additionally forms an electrical series of thermocouple elements, also known as a thermopile. Some of these closed cross-channels 14 and cold junctions 6 therein formed also provide electrical series connections of rows of thermocouple elements 17 shown on FIGS. 2A and 2B.

The electrical connection series in a row of thermopile elements 1 is formed by the electrical connection in the closed cross-channels 14 and cold junction 6 between each thermopile in the row (see, for example, the top row of elements on FIG. 2A) Each of the elements is connected in a series.

The rows of thermopile elements 1 are connected in the closed cross-channel, e.g., electrical row connection 17. For example, the top row of elements is connected to the row below it by the closed cross-channel 17 (and cold junction 6) shown on the figure. That is, the far right thermocouple leg of the top row and the far right thermocouple leg of the row beneath it are connected by the closed cross-channel of the electrical row connection 17. This arrangement is repeated to produce a massive electrical series of thermocouples. As such, in one embodiment, all thermopile elements 1 are electrically connected in series.

The deposition of thermocouple materials specified in FIG. 1, is in a length, width, and depth that provides for relatively low electrical resistance, allowing for a relatively high current flow and, accordingly, a high wattage output when the thermocouples in the device are arranged in a massive series. This relatively heavy deposition of thermocouple materials contributes to its efficiency in power generation. Heavier thermocouple-material deposition reduces the electrical resistance of the thermocouple elements 1 and will in turn reduce the overall electrical resistance of the device. 3-D printing (additive manufacturing) is particularly suitable to this operation as it can form channels which are difficult to produce using more conventional methods.

FIG. 2B shows a reverse angle of the three-dimensional image of the thermopile device shown in FIG. 2A. Positive lead 19 is visible in FIG. 2B.

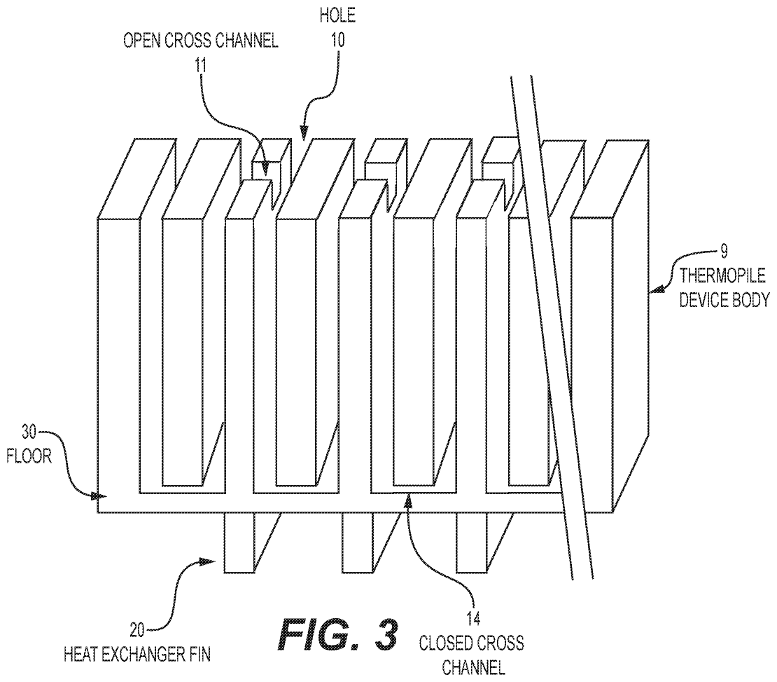

FIG. 3 provides a supplemental, oblique cross-sectional view of holes 10 and cross-channels 11 formed in the body 9 of the Embodiment A of the thermopile device 7. Hot thermocouple junctions 4 are formed on the top of the thermocouple device 7.

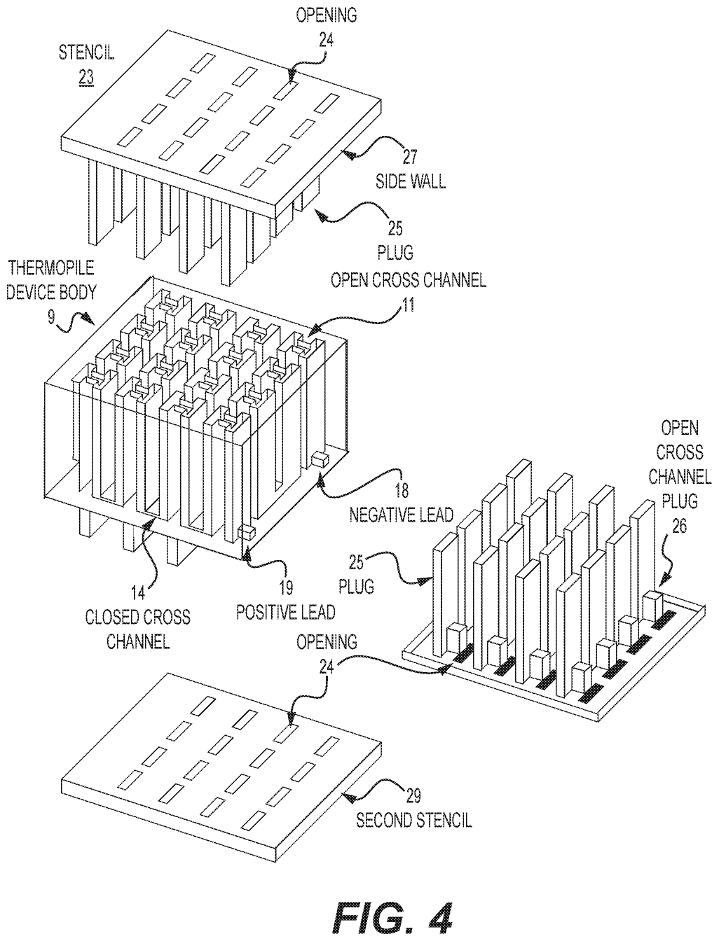

FIG. 4 shows a stencil 23 for fabricating the device 7 which provides for the deposition of powdered or paste-form thermocouple materials into the appropriate holes 10 and open cross-channels 11 in the electrically-insulative body of the Embodiment A. FIG. 4 shows the stencil 23 as it would be inserted into the thermocouple device 7. This stencil 23 also provides plugs 25 that prevent the introduction of the positive and negative thermocouple materials 2, 3 into incorrect holes 10 and cross-channels 11 in the thermopile device body 9. The stencil 23 guides the deposition of thermocouple materials 2, 3 into the correct holes 10 and open cross-channels 11 that have been pre-formed in the device body 9 while simultaneously blocking deposition of these materials into incorrect cavities. Openings 24 are provided in the stencil 23 for preferential deposition of thermocouple materials into the pre-formed cavities in the thermopile device body 9. The stencil 23 is also provided with side walls 27 that align the stencil 23 and its openings with the through-holes 10 and cross-channels 11 pre-formed in the body of the device.

On the right side, FIG. 4 also shows the underside of the stencil 23. This figure shows that open cross-channel plugs 26 integral to the stencil 23 are provided for preventing the deposition of thermocouple materials into incorrect cavities in the body 9 of the device which may otherwise enter the cavities by way of open cross-channels 11 formed in the body of the device.

A second stencil 29 is shown at the bottom left of FIG. 4. This stencil 29 without plugs may be employed to guide the deposition of thermocouple material of one polarity into a set of holes 10 when the other set of holes 10 have already been filled with thermocouple material of another polarity.

A third stencil (not shown) without plugs may be employed to guide the deposition of thermocouple materials 2, 3, or a third electrically-conductive material, into an open cross-channel 11 when the two holes 10 have been filled with thermocouple materials. Any of these stencils may be made of any thin and resilient material, preferably plastic or other electrically non-conductive material.

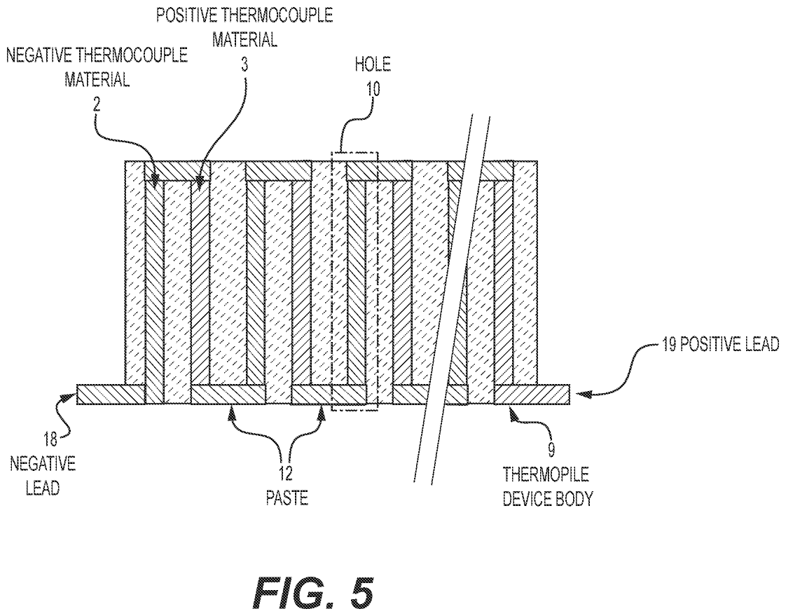

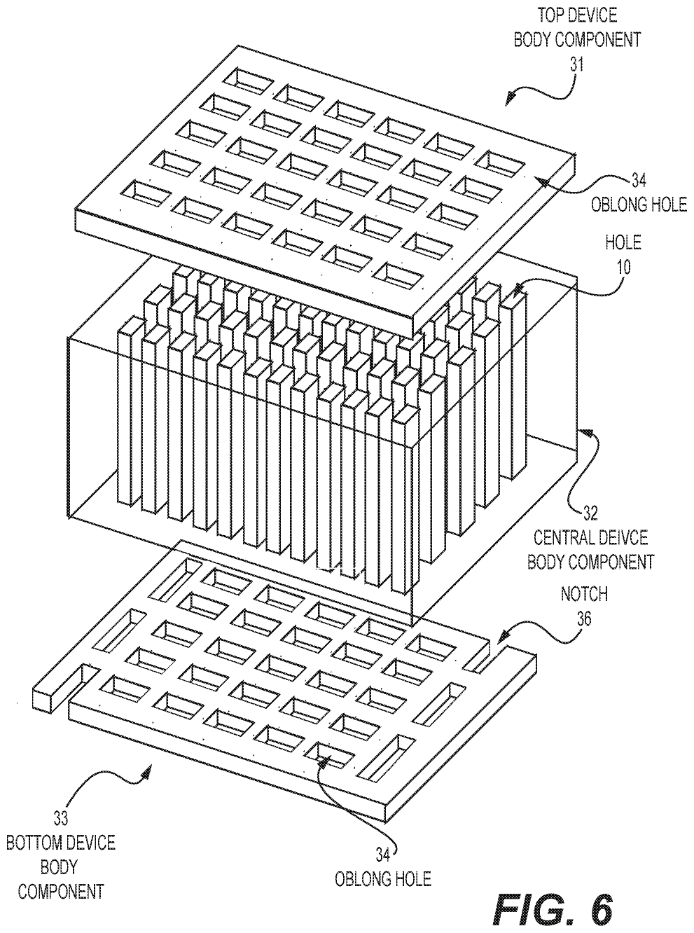

Three exemplary methods of fabricating the thermopile device body 9 for this embodiment are presented as follows and are described with respect to FIGS. 5 and 6. The first provides for the fabrication of a one-piece, pre-formed thermopile device body 9 made of electrically-insulative material, such as a ceramic or glass. In this embodiment, on the cold junction side of the device body 9 where the cold junctions 6 are located, a floor 30 made of ceramic or other electrically-insulative material is provided that forms blind holes 10 and closed cross-channels 14 at the bottoms of the blind holes into which the thermocouple materials are deposited.

FIG. 5 shows a second fabrication method of the thermopile device body 9 wherein pastes 12 comprised of thermocouple materials, or other electrically conductive material, are used to seal through-hole openings on the bottom of the device allowing deposition of powdered thermocouple materials while avoiding leakage of the powders. This second method provides for the fabrication of a one-piece pre-formed thermopile device body 9 made of electrically-insulative material containing through-holes 10 and open cross-channels 11. In this approach, thermocouple material or other electrically conductive material in paste-form 12 is deposited into the open cross-channels 11 on one side of the thermopile device body 9, sealing the cavities so powdered or paste-form thermocouple materials 2, 3 can be deposited in the open ends of the through-holes 10, on the opposite side of the thermopile device body 9 without leakage. A paste 12, such as a metallic brazing compound or a paste made of powdered thermocouple material of a third electrically conductive material may additionally be used to seal the opposite ends of the holes once the thermocouple materials have been deposited. Other sealants may be used as well, such as those which will burn off during the process of sintering or welding the thermocouple materials that have been deposited in the device body.

FIG. 6 shows as third fabrication method wherein three separate electrically-insulative components are combined to form the thermopile device body 9. These components comprise a prefabricated main component 32 shown in the middle having a multiplicity of vertical through holes 10, and two flat components 31,33 used to form cross-channels connecting the holes within the thermopile device body 9 on the top and bottom of the device body (the locations of the hot and cold junctions 4, 6 into which thermocouple materials in powder or paste form will be deposited to form thermocouple junctions. In this third method, the top device body component 31, a central device body component 32 and a bottom device body component 33 may be made by way of 3D-printing, casting, molding, or machining. In this approach, the three components contain through-holes 10. The central component 32 contains through-holes 10 that will contain the thermocouple materials making up the legs 5 of the thermocouple elements 1 while the thinner top and bottom device body components 31, 33 contain oblong through-holes 34 that are fabricated to align with the through-holes 10 in the central component 32 in a manner that joins pairs of through-holes in the central component that contain electrically positive and negative thermocouple materials.

When thermocouple materials, or a third electrically conductive material in powder, paste, wire, or fragment form are deposited into the oblong through-holes 34, 35 in the top electrically-insulative device body component 31 or the bottom electrically-insulative device body component 33, electrical and mechanical connections are produced in the form of thermocouple junctions 4, 6. Deposition of thermocouple materials 2, 3 or a third electrically conductive material in the through-holes of the top device body component 31 forms the hot junctions 4 of the thermopile while deposition of thermocouple material 2, 3 or a third electrically conductive material in the through-holes 34 of the bottom device body component 33 forms the cold junctions 6, the electrical series connections of the device and electrical series connections of rows of thermocouple elements 17 in the device. The deposition of thermocouple material 2, 3 or a third electrically conductive material into the oblong through-holes 34 in the top and bottom device body components 31, 33 additionally bonds the top and bottom device body components mechanically to the middle component 32. Notches 36 in the bottom component provide for the deposition of thermocouple materials or a third electrically conductive material for the formation of outgoing negative and positive leads 18, 19.

Electrically-insulative coatings may be used to enhance device safety and avoid malfunctions. A ceramic, or other electrically-insulative coating, may be deposited over the thermocouple junctions formed on the top and bottom of the device where openings into which the thermocouple materials are deposited are located, to prevent inadvertent short circuits should the junctions come in contact with a conductive material or fluids, and to prevent risk of electric shock to anyone handling the device, or risk of electric shock or electrical interaction with other devices in proximity to the thermopile. However, some configurations of the device may not incorporate this coating. The thicknesses of this coating, as well as the materials used, may be preferentially varied to enhance heat transfer to and from the device and the temperature gradient between the hot and cold junctions 4, 6. Additionally, a material having a high level of thermal conductivity, such as silver or copper, may be used as a coating on this part of the device in a manner that excludes the coating from the thermocouple and thermopile circuits.

The thermopile device 7 allows the use of materials having different thermal conductivities to enhance thermal gradients across the device. Materials having low levels of thermal conductivity may be used in the hot junction area of the thermopile device 7 to retain heat and insulate the rest of the device from the heat source, while materials having a comparatively high level of thermal conductivity in the cold junction area of the device are used to remove heat and keep the cold junctions 6 cool. Higher temperature gradients between the hot and cold thermocouple junctions 4, 6 in a thermopile create higher voltages, and this provision maximizes the temperature differences within these gradients. Additionally, the thermopile device body 9 may be composed of materials that structurally incorporate gradations of thermal conductivity to preferentially direct the flow of heat through the device and enhance the temperature difference between the hot and cold junctions 4, 6 thereby increasing power output.

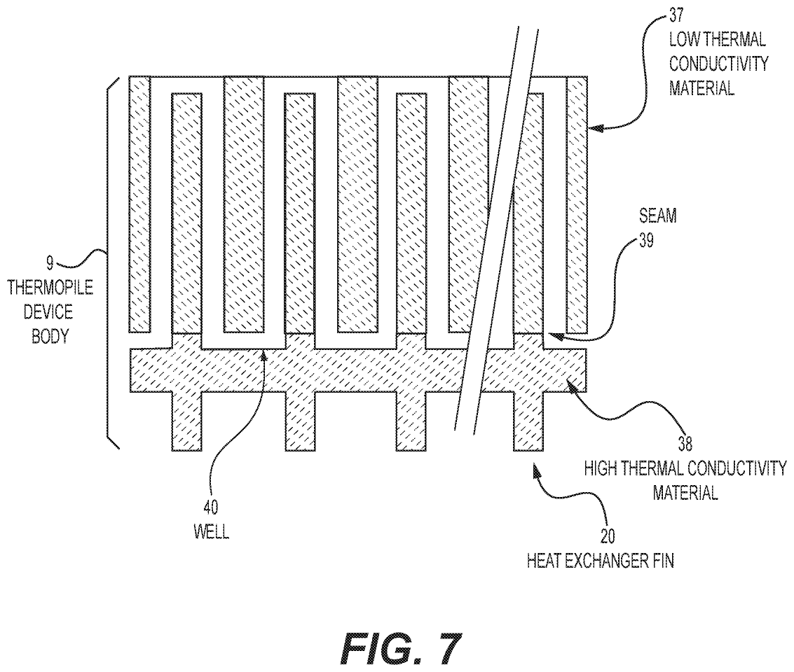

FIG. 7 shows the use of electrically-insulative materials of differing thermal conductivities to fabricate the device body for the purpose of enhancing the thermal gradient between the hot and cold junctions 4, 6 of the device, thereby enhancing voltage output. To achieve the thermal gradient, the thermopile device body 9 may be constructed of two sections, one on the cold junction side of the device body where the cold junctions 6 are located, and one on the opposite hot junction side of the device body where the hot junctions 4 are located. The section located at the hot side of the thermopile device 7 is composed of a material low in thermal conductivity 37 such as zirconium oxide, mullite, silicon dioxide, or borosilicate glass. This material both retains heat and insulates the rest of the thermopile device body 9 from the heat source. The section located at the cold side of the device is composed of a material high in thermal conductivity 38 such as aluminum oxide or aluminum nitride which more readily dissipates heat. The high and low thermal conductivity electrically-insulative components are durably joined at a seam 39 either by fusing the two components via sintering, by the use of a cement, or by mechanical means.

An optional way of forming thermocouple cold junctions 6 is provided for this embodiment in FIG. 7. Here, wells 40 are formed in the high thermal conductivity electrically-insulative component 38 that serves as the base of the thermopile device body 9. These wells 40 function in the same manner as the closed cross-channels 14 described above and are filled with thermocouple materials 2, 3 to form cold junctions 6, electrical series connections of thermocouple elements, and electrical series connections of rows of thermocouple elements 17.

Additionally, the thermopile device body 9 may be constructed in layers producing a gradation of thermal conductivity, with the lower conductivity layers being located at the hot extremity of the thermopile device 7 and with the higher conductivity layers being located at the cold extremity of the device.

Alternatively, the thermopile may be constructed of a material that has been preferentially formed with a gradation of material density such that the denser material is located at the hot extremity of the thermopile device 7 and the less dense material is located at the cold extremity of the device. This material may be of a high or low thermal conductivity.

Another option is that the thermopile may be constructed of a material that has been preferentially formed with a smoothly gradated combination of materials such that there is a high proportion of low conductivity material located at the hot extremity of the thermopile device 7 and a high proportion of high conductivity material located at the cold extremity of the thermopile device.

The thermopile device body 9 also may simply have sections or coatings of metal, ceramic or composite materials with differing thermal conductivities located at the hot and cold extremities of the thermopile device 7 which enhance the thermal gradient in the device.

This embodiment also provides for the formation of heat-exchanger fins 20 on the external surface of the device where the cold junctions 6 are located as shown in FIGS. 1-4. These heat exchanger fins 20 are made of an electrically-insulative material (e.g., ceramic) used in the main body of the device. The strips of electrically-insulative material are located between rows of thermocouple elements 1. The heat exchanger fins 20 add surface area to the cold junction side of the device to enhance thermal exchange, and the geometry of these fins may be preferentially varied to produce optimal heat transfer effects. In particular, the heat exchanger fins 20 may be made of a material with a much higher heat transfer coefficient than the rest of the device, promoting heat rejection in the area of the cold junction 6.

Another method of achieving the heat-transfer enhancement in this embodiment is to form the body of the device in three parts 31, 32, 33 as described previously with respect to FIG. 6. In this embodiment, each of the three parts is made of an electrically-insulative material having differing heat transfer coefficients 37, 38. This multiple layer arrangement may provide preferential gradients of heat transfer properties.

### Embodiment A: Manufacturing Process

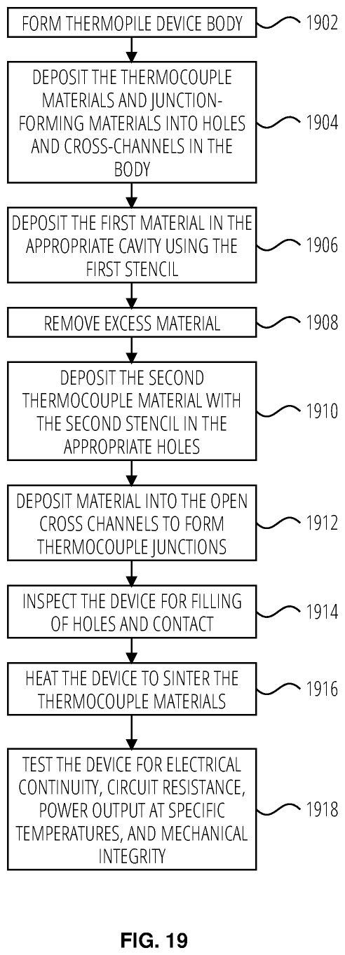

FIG. 19 illustrates a flowchart for a process of manufacturing the thermopile device 7 in one embodiment. The first step in the manufacturing procedure is to fabricate the thermopile device body 9 which is a block such as the one shown in FIG. 2 that is made of ceramic or other electrically-insulative material (step 1902). Next, the thermocouple materials and junction-forming materials are firmly deposited into the appropriate holes 10, and cross-channels 11, 14 in the electrically-insulative (e.g., ceramic) body of the device 9 (step 1904). Each material is deposited independently of the other. These materials are swept into the holes 10 and cross-channels 11, 14 using the stencil 23 or stencils shown in FIG. 4, and may also be tamped into place using the plugs 25 provided in one of the stencils 23.

In the thermocouple-material deposition procedure, the first material 2 or 3 is deposited in the appropriate cavity using the first stencil 23 and a squeegee or similar tool and tamped into place (step 1906). Excess material is brushed away or otherwise removed (step 1908). Next, the second stencil is moved to the appropriate position for deposition of the second material, and the second material is deposited into the appropriate thermocouple leg channels and cross-channels 11, 14 which form the hot and cold thermocouple junctions 4, 6, as shown in FIG. 4 (step 1910). Either the positive or negative thermocouple materials 2, 3 may be deposited into these open cross-channels 11 to form thermocouple junctions 4, 6 (step 1912). Alternatively, a third material which may be one with high thermal conductivity such as copper or silver, may be deposited in the cross-channels while maintaining, in accordance with the Law of Intermediate Materials, the thermoelectric effect. This is described, for example, in Robert P. Benedict, Fundamentals of Temperature, Pressure, and Flow Measurements (New York: John Wiley & Sons, 1984), p. 89, which is incorporated by reference herein. Such a third material may be included in the formation of either the hot or cold thermocouple junctions 4, 6 or both. The open ends of the cavities may be sealed with paste 12 comprised of thermocouple materials or a third electrically conductive material, or a sealer that will burn off.

An alternative approach to the use of an additional stencil (or potentially two additional stencils) is to simply sift or squeegee the second thermocouple material across the top of the device after the first thermocouple material has been tamped into place. In this case, the second material fills the empty cavities but will not enter the cavities that have already been filled. This second thermocouple material will additionally fill the open cross-channels 11, forming thermocouple junctions.

Next, the device is inspected to assure that the thermocouple materials fill the cavities completely, in one embodiment, with the appropriate volume and density, and that the positive and negative thermocouple materials come into contact in the appropriate places, and that electrical series connections are made in the appropriate places (step 1914).

Then, the device is place into a controlled atmosphere furnace at a temperature appropriate to sintering (or melting, as required) the powdered or paste-form thermocouple materials 2, 3 (step 1916). This heating procedure may need to be repeated when powdered or paste-form thermocouple materials shrink in volume during the heating process, necessitating the addition of more material into the cavities in the body of the device and additional heating to sinter or melt the added thermocouple materials. This process can also be done in stages, with sintering or melting of high melting-point materials done first and sintering or melting of lower temperature materials done second.

The next step in the manufacturing procedure is a series of acceptance tests to assure electrical continuity throughout the device, proper circuit resistance, proper power output at specific temperatures, and overall mechanical integrity (step 1918).

Provisions should also be made in the geometry of the device to allow for the thermal expansion or contraction of the materials used which may occur both during fabrication of the device and its use. The thermocouple materials, initially provided in powder or paste form, will have microscopic empty spaces between granules, and the powder or paste will shrink somewhat in the heating process used to sinter or melt the thermocouple materials into place. As noted above, steps 1904-1916 may be repeated when necessary to fill the channels completely due to thermocouple material volume shrinkage. Generally, the thermocouple materials will have a greater coefficient of thermal expansion than the electrically-insulative materials. Accordingly, the present device-body design also provides space for additional expansion of the thermocouple-material elements 1 at the top of the thermopile device body 9 where the thermocouple materials are deposited into the body while the initial granular form of the materials, and remaining spaces between particles subsequent to sintering or melting also provides space for thermal expansion.

Another feature of the design is that the hot and cold thermocouple junctions 4, 6 formed at both the top and bottom of the device body (see FIG. 1) have the mechanical effect of holding the thermocouple-material elements into place within the hollow cavities provided, and in the case of the embodiment of FIG. 6, holding the three disparate electrically-insulative parts together mechanically.

### Embodiment B

FIGS. 8-13 and 20 illustrate Embodiment B. Embodiment B is a design wherein both the thermocouple elements 1 and the electrically-insulative thermopile device body 9 are 3D-printed simultaneously using any of a variety of additive manufacturing (3D printing) processes such as stereolithography and potentially, other additive manufacturing methods such as selective laser sintering, binder jetting, and powder bed fusion.

FIGS. 8A-8C illustrate the construction of the thermocouple elements 1 and the electrically-insulative (e.g., ceramic) substrate, and the provision for thermal expansion of the materials during production and use of the device. FIGS. 8A and 8B show 5 intermediate layers, although there are more layers, as these layers are repeated. FIG. 8C shows the bottom and top layer.

In this embodiment, each thermocouple element 1 comprises three areas of sintered or melted material: an electrically negative thermocouple material 2 in powder, paste, or ink form; an electrically positive thermocouple material 3 in powder, paste, or ink form, and an electrically-insulative material 9 such as aluminum oxide, mullite, or silica glass. These thermocouple material powders or pastes 2, 3 are deposited on substrates of electrically-insulative material such as a ceramic or glass 9, that electrically insulates each layer of deposited thermocouple material 2, 3, comprising a row of thermocouple elements 1 in electrical series, from the other.

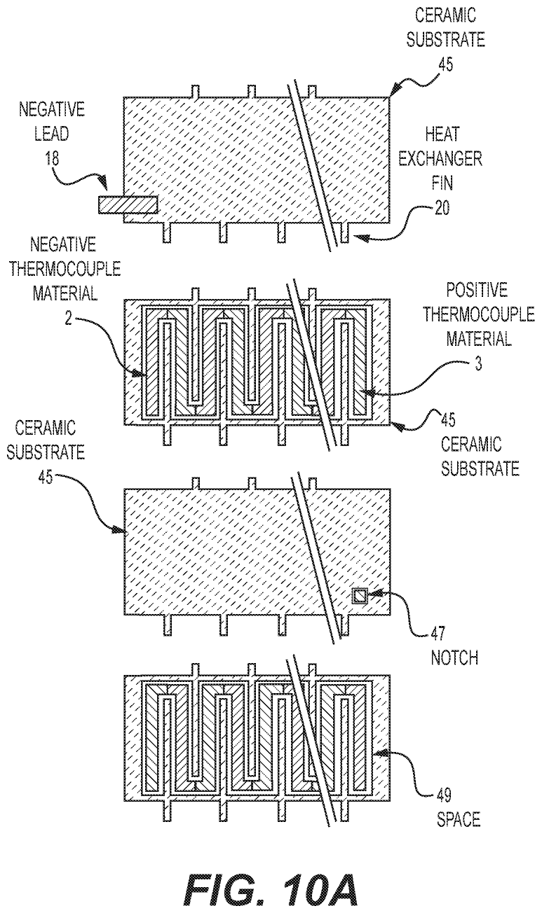

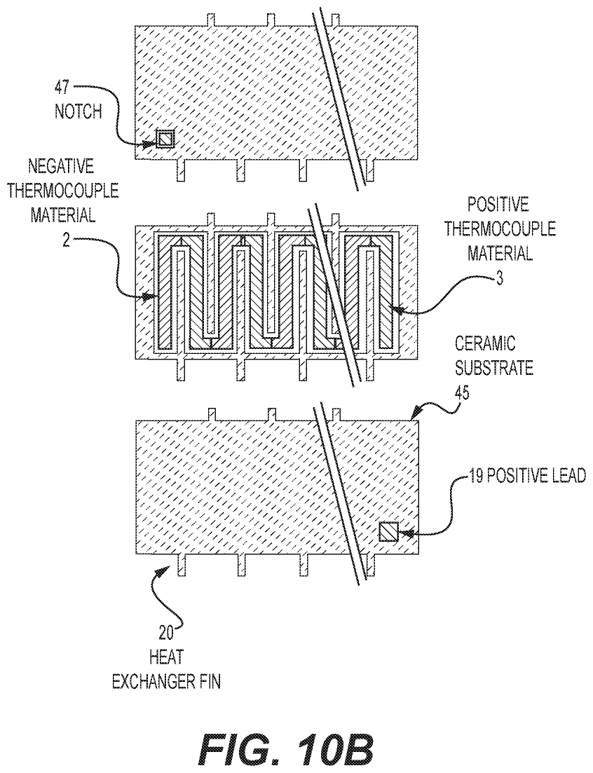

Within these substrates 45, a deposition of thermocouple material 2, 3 is provided for electrical series connection of layers of thermocouple elements comprising one row of thermocouple elements 1 as illustrated in FIGS. 8-10. Electrical series connections of rows of thermocouple elements 17 are produced by way of notches 47 on alternating sides (on the horizontal axis of the electrically-insulative substrates 45, on which the positive and negative thermocouple materials 2, 3, forming rows of thermocouple elements 1, have been deposited. Each notch 47 is a cavity formed in the electrically-insulative substrates which is filled with a positive and negative thermocouple material 2, 3 in powder, paste, or ink form and provides a connection to a thermocouple material having the opposite electrical polarity that has been printed on a substrate layer above this electrically-insulative substrate. This connection provides an electrical series arrangement of thermocouples. These notches 47 are also used to form outgoing positive and negative leads 18, 19 as is illustrated in FIGS. 8C and 10A.

On the face of each layer, the areas of deposited positive thermocouple materials 3 are separated and insulated from the areas of deposited negative thermocouple materials 2, except where they form hot and cold thermocouple junctions 4, 6, by areas of ceramic or other electrically-insulative material 45 that has been deposited on the same plane as the positive and negative thermocouple materials 2, 3. Alternatively, the positive thermocouple materials are separated and insulated from the areas of deposited negative thermocouple materials 42, except where they form thermocouple junctions 4, 6, by a space between or around deposited thermocouple materials 49.

As shown in FIG. 8A, going from left to right, the last thermocouple leg 2, 3 in the row of these thermocouple elements 1 (in this case, on Layer 1, a positive leg), is joined to the first thermocouple leg going from right to left, of the next layer (on Layer 3; in this case, a negative leg). As noted above, these legs are joined to form electrical series connections of rows of thermocouple elements 17 by way of notches 47 on alternating sides (on the horizontal axis) of the electrically-insulative substrate, Layer 2, providing electrical-series connections on the electrically-insulative substrate on which the thermocouple materials 2, 3 forming thermocouple elements 1 have been deposited. Thermocouple materials 2, 3 are printed in an order of positive and negative electrical polarities opposite to those in previously printed layers in the construction of the device as is shown in the printing sequence shown in Layer 3. This arrangement of substrates, printed thermocouple materials, and connections of layers and rows of thermocouple elements 1 is repeated to produce an electrical series of thermocouples that can be any number of thermocouples.

The positive and negative thermocouple materials 2, 3 in this embodiment are deposited in a thickness that provides for relatively low sheet resistance, allowing for a relatively high current flow and, accordingly, a high wattage output. This relatively thick layering contributes to its efficiency in power generation. Thicker thermocouple material deposition reduces the sheet resistance of the thermocouple elements 1 and in turn reduces the overall electrical resistance of the device and accordingly, increases the current level and wattage output of the device. Thinner deposition reduces the sheet resistance.

In one embodiment, 3-D printing is used to fabricate a plurality of thermocouple elements 1 in the thermopile device 7 as one unit with each cross-sectional layer of all of the linear units being printed at one time (as shown in FIG. 3). For a 25,000-element thermopile, each layer might include 50 thermocouples, and 500 such layers would be printed in order to produce a 25,000-element thermopile unit. Printing processes other than 3-D (“additive manufacturing”) systems may, however, be used to achieve the layered configuration of the device, such as is described in Embodiment C below.

Additionally, as noted in Embodiment A, above, a ceramic, teflon, silicone, or other electrically-insulative coating may be provided over either the hot and cold junctions 4, 6 to prevent inadvertent short circuits should the junctions come in contact with a conductive material or fluids, and to prevent risk of electric shock to anyone handling the device, or risk of electric shock or interaction with other devices in proximity to the thermopile. This exterior coating may be provided on all sides of the device shown in FIGS. 8, 10, and 11 with the exception of the outgoing positive and negative leads 18, 19. Some configurations of the device may not incorporate this coating. The thicknesses of this coating, as well as the materials used, may be preferentially varied to enhance heat transfer to and from the device and the temperature gradient between the hot and cold junctions 4, 6.

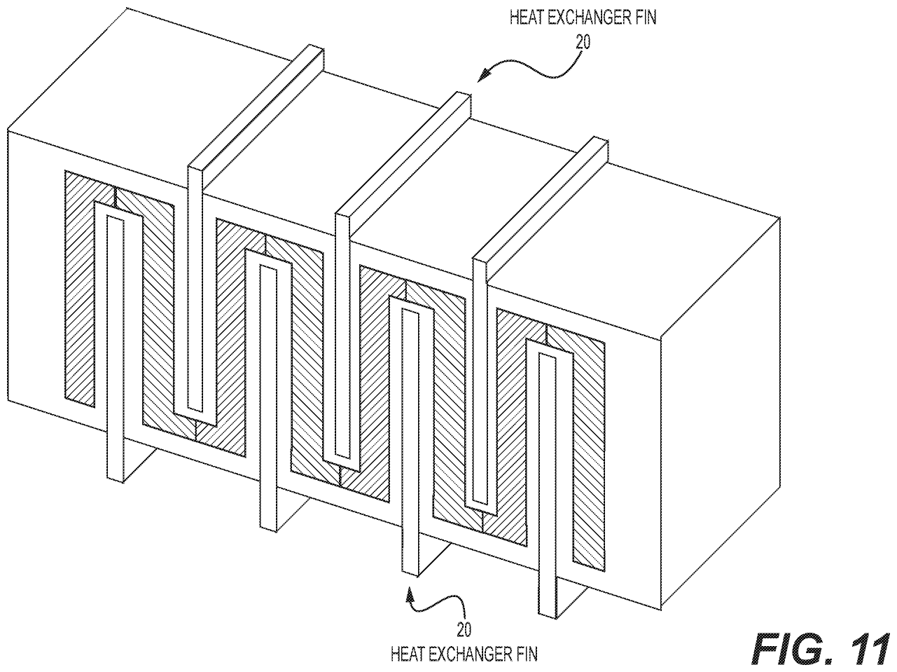

As noted in Embodiment A, the design also provides for the formation of external heat-exchanger fins 20 on the sides of the thermopile device 7 where the cold junctions 6 are located as shown in FIGS. 10 and 11. These fins are made of the same electrically-insulative (e.g., ceramic) material as the electrically-insulative substrates 45. The areas of electrically-insulative material separating the thermocouple elements 1 on each layer are formed to extend beyond the thermocouple materials and the walls of the device on the top and bottom (hot and cold sides) to form heat exchanger fins 20. The heat exchanger fins 20 add surface area to the cold junction side of the device body 9 to enhance thermal exchange in that area, and the geometry of these fins may be preferentially varied to produce optimal heat transfer effects. The heat exchanger fins 20 also help to keep the thermocouple elements 1 from coming into direct contact with other objects if a ceramic coating is not used over the hot and cold junctions 4, 6.

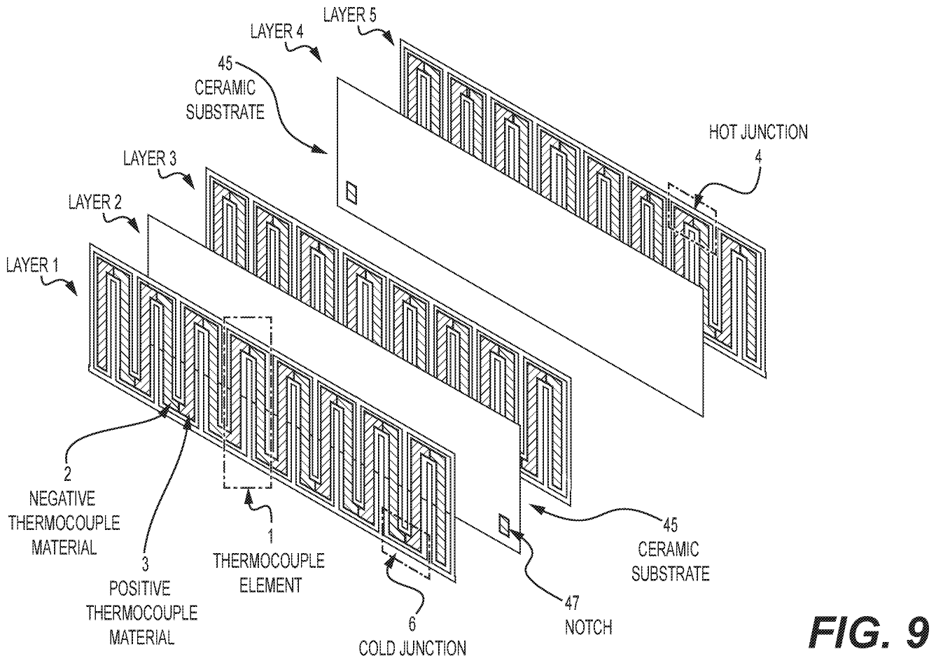

FIG. 9 illustrates the arrangement of the thermocouple elements shown in FIGS. 8A-C into a stacked form; this stack can be extended in depth and width to the extent permissible by 3-D printing machinery, and can subsequently be extended by combining 3-D-printed units in electrical series.

FIG. 10 illustrates the printing process indicating the arrangement of thermocouple materials and substrate materials on each printed layer. As shown on FIG. 10, fins are added to the substrate 45.

FIG. 11 illustrates the arrangement of electrically-insulative material (e.g., ceramic) between thermocouple elements (as also shown in FIG. 3) to form external fins providing a heat exchanger function and that allow handling and situating of the device without touching the thermocouple elements.

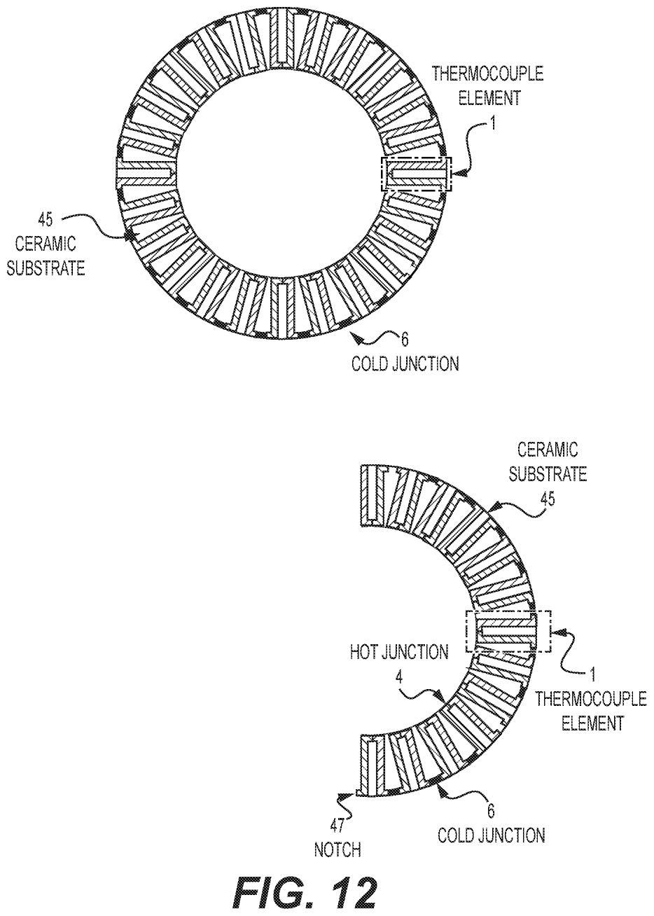

FIG. 12 illustrates the arrangement of printed thermocouples into ring form and semicircular form both of which can be used to surround pipes and capture waste heat. The stacking method used in constructing the thermopiles can be used to produce a variety of shapes such as these.

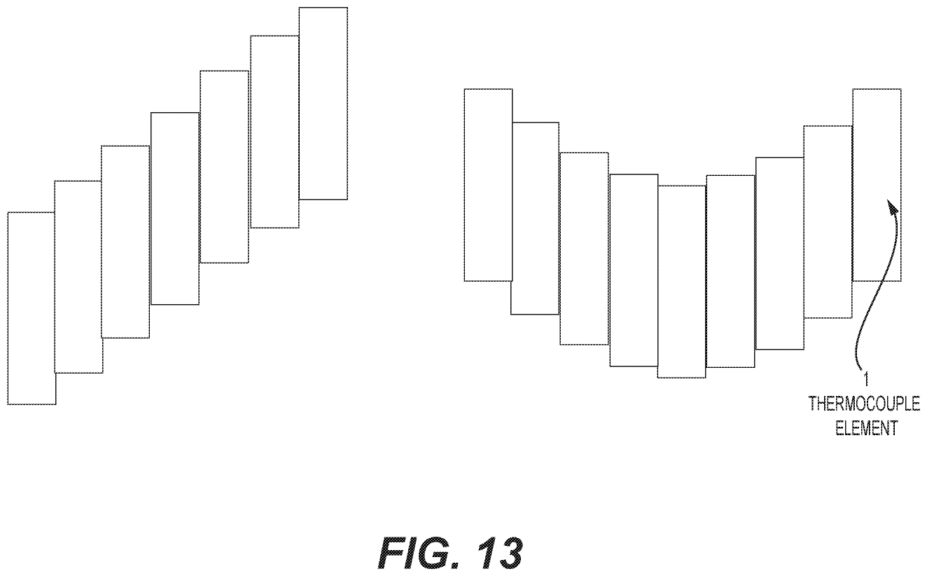

FIG. 13 shows how thermocouple elements can be arranged in staggered configurations 53 to conform to curved, angled, or irregularly shaped surfaces.

As noted in Embodiment A, electrically-insulative materials having different heat-transfer properties 37, 38 may be used preferentially to enhance the thermal gradient within the device, in turn enhancing the power output produced by thermoelectric effect of the thermocouple materials within the device.

As noted above, any materials having a thermoelectric effect, including but not limited to, copper, Constantan, Alumel, Chromel, Monel, Nichrome, iron, platinum and platinum alloys, tungsten and tungsten alloys, bismuth telluride, silicon germanium, lead telluride, tetrahedrites, and other novel and non-standard thermoelectric materials may be used to fabricate the device.

Provisions may be made in the geometry of the device to allow for the thermal expansion of the materials used. Generally, metallic materials that may be used have a greater coefficient of thermal expansion than the electrically-insulative materials (e.g., ceramics). Accordingly, the present design provides for expansion of metallic elements. This is done by providing a space 49 between or around deposited thermocouple materials comprising the thermocouple elements 1 deposited on each printed layer into which the heated thermocouple materials 2, 3 may expand both during the operation of the device and during any heat-treating processes that may be necessary in manufacturing to effect melting or sintering of the powered materials.

### Embodiment B: Manufacturing Process

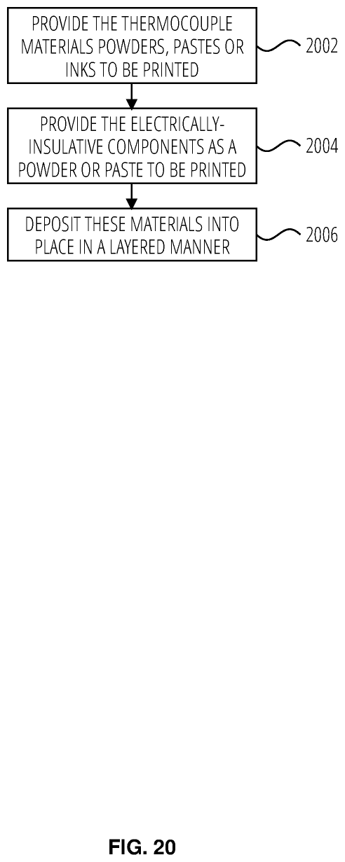

FIG. 20 illustrates a flowchart of steps for simultaneously printing the materials. This embodiment is achieved by 3D printing the materials simultaneously in the manner shown in FIGS. 8 to 13. Laser sintering and other high-energy, high-speed fusion methods may be used to sinter or melt materials as deposited. Alternatively, stereolithography and other 3D printing methods may be used in a manner that yields a green-state part that is thermally processed in a reducing, oxidizing, inert, or vacuum atmosphere or combinations thereof, after printing is completed. In this process, the shape and volume of components made of thermocouple materials is engineered to allow thermal expansion and shrinkage at various stages of fabrication and device use.

The thermocouple materials 2, 3 to be used in the device are provided as powders, pastes, inks or in other forms that allow them to be printed as required by the design of the device (step 2002). The electrically-insulative (e.g., ceramic) components 44, 45 are also provided as a powder or paste or in other forms that allow it to be printed as required by various embodiments of the device (step 2004). These materials are deposited into place (and may be sintered or melted or otherwise fixed in place) in a layered manner (as shown in FIGS. 8-10) using a 3-D printing process or other printing processes that allow layering and fixing in place of printed thermocouple elements 1) (step 2006). Powdered materials may be delivered for use in printing in the form of inks or pastes containing binder materials that are burned off in the fabrication process.

### Embodiment C: Description and Manufacturing Process

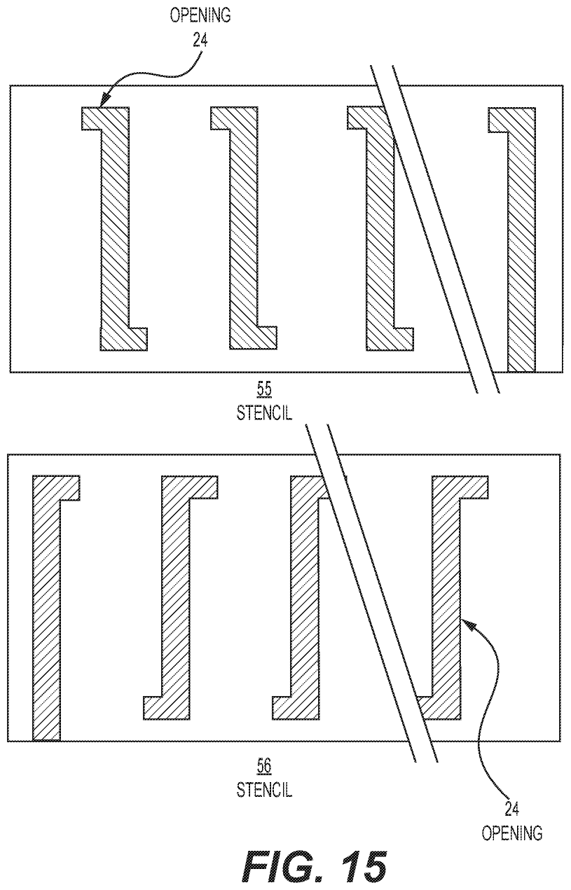

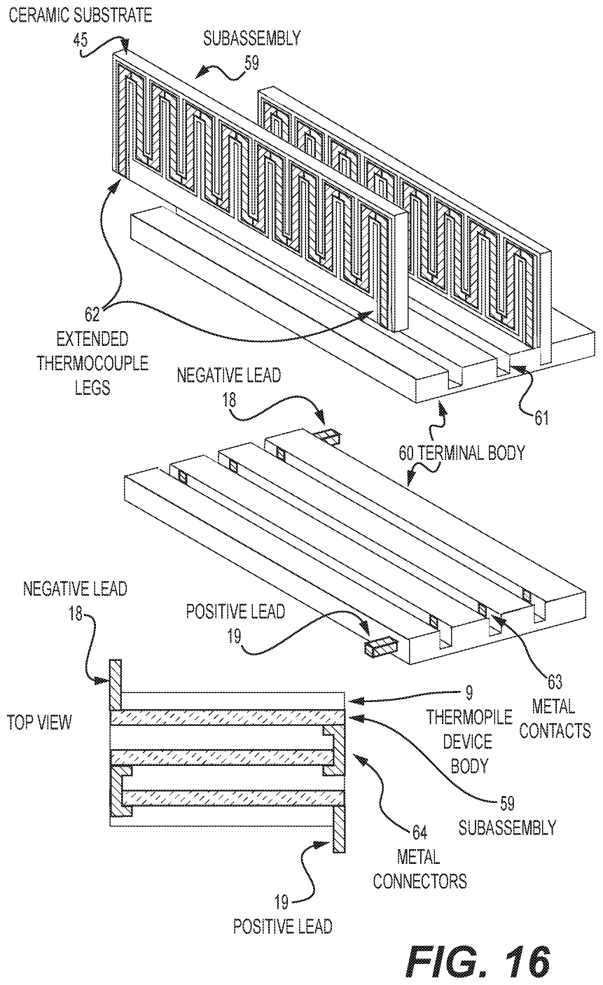

FIGS. 14, 15, and 16 illustrate Embodiment C which achieves a result similar to Embodiment B by way of depositing each layer of thermocouple elements separately on a pre-formed electrically-insulative substrate 9 using stencils 55, 56 (see FIG. 15) having openings 24 for the deposition of positive and negative thermocouple materials 2, 3. Then the process assembles the layers, manually or mechanically, into a terminal, shown in FIG. 16, that connects the layers in electrical series.

FIG. 14 shows a pre-formed electrically-insulative substrate having pre-formed channels 66 designed to accept positive and negative thermocouple materials 2, 3 in powder or paste form which will form an array of thermocouples in electrical series. In this embodiment, the electrically-insulative substrate 9 is pre-formed and fired, in the case of ceramics, to achieve the required shape, density, and hardness. The positive and negative thermocouple materials 2,3 in powder or paste form are deposited in the appropriate shapes or in the appropriate pre-formed channels 66 in a second operation, and then the entire assembly is heated in a controlled atmosphere to sinter or preferentially melt the deposited thermocouple materials. The scheme of arrangement of metals exhibiting positive and negative polarities is the same as that shown in FIGS. 8-10. Silkscreening methods, or other conventional electronic printing processes, may alternatively be used to deposit the positive and negative thermocouple materials 2, 3 on the substrates 9.

FIG. 15 illustrates stencil designs used to deposit thermocouple materials on the pre-formed electrically-insulative substrates or in the pre-formed channels 66 depicted in FIG. 14. Stencil 55 has openings 24 to accept one type (e.g., positive) thermocouple material, and stencil 56 has openings 24 to accept the opposite type of thermocouple material (e.g., negative 2).

FIG. 16 depicts a terminal into which the subassemblies, also depicted in FIG. 16, above, containing thermocouples in electrical series, are assembled into a larger electrical series. Deposition of thermocouple materials onto electrically-insulative substrates, as shown in FIGS. 14 and 15, produces completed subassembly 59 layers that are then assembled manually or mechanically, into a terminal 60 that connects the subassembly layers in electrical series.

Each subassembly is inserted into a groove 61 formed in the terminal 60. Thermocouple elements 1 at the ends of each subassembly have extended thermocouple legs 62 to reach and be placed in firm connection with metal contacts 63 that are part of metal connectors 64 embedded in the terminal 60 that join the subassemblies 59 in electrical series. A construction similar to that of the connectors provides for outgoing leads 18, 19.

In this embodiment, the electrically-insulative substrate 45 used in each subassembly layer 59 is pre-formed and fired to achieve the required density and hardness. The thermocouple-material powders or pastes 2, 3 are printed or deposited in a second operation, and then the substrate containing the thermocouple materials is heated in a controlled atmosphere to sinter or preferentially melt the deposited thermocouple materials 2, 3. In this embodiment, the thermocouple materials may be printed on a flat substrate. The scheme of arrangement of positively and negatively charged thermocouple materials 2, 3 is the same as that shown in FIGS. 8 to 13. FIG. 14, however, shows how the electrically-insulative substrate can have pre-formed channels 66 in it to accept thermocouple materials in powdered or paste form 2, 3. This embodiment may also incorporate arrangements of multiple electrically-insulative materials to enhance heat transfer as in the description of Embodiment A, and heat-exchanger fins described in the description of Embodiment B.

### Embodiment D: Description and Manufacturing Process

FIGS. 17 and 18 illustrate Embodiment D. FIG. 17 depicts an electrically-insulative body having preformed through-holes, into which thermocouple materials, in powder or paste form, are deposited, producing the positive and negative legs of individual thermocouple elements 1. Thermocouple junctions are then formed on the top and bottom of the electrically-insulative body by depositing thermocouple materials in paste form in a manner that joins the thermocouple legs at the openings of the through-holes, on the surface of the device body, without the use of cross-channels described in the first embodiment.

Embodiment D is achieved by depositing thermocouple metals, in powder or paste form 2, 3, into preformed through-holes 10 in an electrically-insulative thermopile device body 9, producing the positive and negative legs 2, 3 of individual thermocouple elements 1, and then forming thermocouple junctions 4, 6 on the top and bottom of the electrically-insulative body by depositing thermocouple material in paste form in a manner that joins the thermocouple legs at the openings of the through-holes, thus forming thermocouple junctions on the surface of the thermopile device body 9, without the use of cross-channels described in the first embodiment. Either the hot junction 4 or cold junction 6 may be made of electrically-negative thermocouple material 2 or electrically positive thermocouple material 3, or a third material.

As in the other embodiments, the powder or paste-form thermocouple materials are later sintered in a controlled atmosphere to form highly integrated material form.

FIG. 18 depicts stencils which guide the junction-forming pastes into the proper places in the embodiment depicted in FIG. 17. As shown, stencils 67, 68 may be used to guide the junction-forming thermocouple materials in paste form into the proper place. These stencils contain holes 24 to guide the deposition of thermocouple materials or other electrically conductive materials 2, 3 to the correct areas on the thermopile device body 9 for forming thermocouple junctions 4, 6. The stencils 67, 68 also contain openings 71 for depositing thermocouple materials, or other electrically conductive materials, onto the device body 9 to produce connections of rows of thermocouple elements, thus forming an electrical series between rows of thermocouple elements, and openings 72 to for depositing thermocouple materials, or other electrically conductive materials, onto the device body to produce outgoing thermopile leads 72. Alternatively, other mechanical or automated methods of depositing pastes comprised of thermocouple materials in the proper locations, such as those used to fill drug capsules, may be used.

In general, many materials possessing thermoelectric effects may be used in this many of the embodiments described herein. For the purposes of illustration, a thermoelectric analysis using Type K (Chromel vs. Alumel) is provided. Type K thermocouples produce approximately 8.14 mV when a temperature difference of 200° C. (392° F.) occurs between the hot and cold junctions 4, 6. A thermopile, which is an assembly of multiple thermocouples connected in an electrical series, produces an additive voltage effect when the hot junctions 4 are at one temperature and the cold junctions 6 are at another temperature. Additive voltage levels for type K thermopiles wherein there is a 200° C. temperature gradient from the hot junctions 4 to the cold junctions 6 are as follows:

8.14 mV=1 junction

81.4 mV=10 junctions

814 mV=100 junctions

8.14 V=1,000 junctions

81.4 V=10,000 junctions

814 V=100,000 junctions

8,140 V=1,000,000 junctions

Higher temperature gradients between the hot and cold thermocouple junctions in the device will create higher voltages. As noted above, the dimensions of the thermocouple elements (1) can be preferentially varied to produce an electrical circuit resistance that will provide an appropriate current level for various power-generation applications.

Many materials having thermoelectric effects, including but not limited to, copper, Constantan, Alumel, Chromel, Nichrome, Monel, iron, platinum and platinum alloys, tungsten and tungsten alloys, bismuth telluride, silicon germanium, lead telluride, tetrahedrites, and other novel and non-standard materials exhibiting thermoelectric effects may be used in this design. As noted above, these materials need not be standard, commonly used thermocouple materials.

A wide variety of electrically-insulative materials can also be used where required in the design, in particular, in the body of the device. These materials include, but are not limited to, aluminum oxide, aluminum nitride, silicon dioxide, calcium oxide, zirconia, mullite, magnesium oxide, boron nitride, and combinations thereof. These materials should be able to withstand high temperatures in order to allow sintering or melting of the thermocouple materials into place within the device body in the manufacturing processes described herein. Additionally, the materials used in the design can withstand elevated temperatures for extended periods of time, a capability that is important in applications such as ceramics and metals processing where temperatures can reach 1649° C./3000° F.); natural gas, petroleum, and coal combustion for power generation where temperatures can reach 1,427° C./2,600° F.; solid waste disposal where temperatures can reach 760° C./1,400° F., wood, paper, and pulp processing where temperatures can reach 1,038° C./1,900° F., and automotive engine operation where temperatures can reach 700° C./1292° F. The device can additionally be incorporated into primary power-generation system using solar, biomass, nuclear, and geothermal heat sources wherein temperatures can range from 150° C./302° F. to 1,649° C./3,000° F.

The foregoing description of various embodiments provides illustration and description, but is not intended to be exhaustive or to limit the invention to the precise form disclosed. Modifications and variations are possible in light of the above teachings or may be acquired from practice. It is to be understood that the invention is intended to cover various modifications and equivalent arrangements included within the spirit and scope of the appended claims.

What is claimed is:

1. A thermopile including a series of thermocouples, comprising:
a heat-resistant, electrically-insulative container, comprising:
a first hole configured to receive an electrically-positive thermocouple material;
a second hole configured to receive an electrically-negative thermocouple material parallel to the first hole; and
a cross-channel connecting the first hole and the second hole such that, when the heat-resistant, electrically-insulative container is heated with the electrically-positive thermocouple material deposited in the first hole and the electrically-negative thermocouple material deposited in the second hole, the cross-channel forms a hot junction in a thermocouple element formed by the electrically-positive thermocouple material and the electrically-negative thermocouple material.

2. The thermopile of claim 1, wherein the heat-resistant, electrically-insulative container is made of ceramic or glass.

3. The thermopile of claim 1, wherein the heat-resistant, electrically-insulative container is heat resistant above 500 degrees C. for melting the deposited electrically-positive thermocouple material and the electrically-negative thermocouple material.

4. The thermopile of claim 1, wherein the cross-channel is an open cross-channel.

5. The thermopile of claim 4, wherein the second hole is connected by a closed cross-channel to:
a third hole configured to receive a second electrically-positive thermocouple material, which is connected by a second closed cross-channel to:
a fourth hole configured to receive a second electrically-negative thermocouple material parallel to the third hole, thereby creating two thermocouple elements when electrically-positive and electrically-negative thermocouple material is deposited and heated in the first, second, third and fourth holes.

6. The thermopile of claim 1, wherein the electrically-positive thermocouple material and the electrically-negative thermocouple material is one of: iron, copper, nickel-chromium, nickel-aluminum alloys, Constantan, Nichrome, Monel, and nickel.

7. A thermopile for withstanding high heat, comprising:
a heat-resistant, electrically-insulative container comprising:
a plurality of rows of holes configured to receive electrically-positive thermocouple material and electrically-negative thermocouple material;
each row of holes comprising a plurality of pairs of holes, and connected by a cross-channel to one or more other rows of holes;
each pair of holes connected to one or more other pair of holes in the same row by a cross-channel; and
each hole in the pair of holes connected to each other with an cross-channel,
such that when the electrically-positive thermocouple material and the electrically-negative thermocouple material is deposited in the holes and the heat-resistant, electrically-insulative container is heated:
the electrically-positive thermocouple material and the electrically-negative thermocouple material form thermocouple elements in the holes;
the open cross-channels form hot junctions and cold junctions of the thermocouple elements; and
the thermocouple elements are electrically-serially connected throughout the heat-resistant, electrically-insulative container to form the thermopile.

8. The thermopile of claim 7, wherein the heat-resistant, electrically-insulative container is made of ceramic or glass.

9. The thermopile of claim 7, wherein the heat-resistant, electrically-insulative container has external fins configured to reduce heat.

10. The thermopile of claim 7, wherein the electrically-positive thermocouple material and the electrically-negative thermocouple material is one of: iron, copper, nickel-chromium, nickel-aluminum alloys, Nichrome, Monel, and nickel.

11. The thermopile of claim 7, wherein the heat-resistant, electrically-insulative container is heated above 500 degrees C. to sinter the electrically-positive thermocouple material and the electrically-negative thermocouple material in the holes.

12. The thermopile of claim 11, wherein the heat-resistant, electrically-insulative container is configured to be heated up to 1500 degrees C. to sinter or melt the electrically-positive thermocouple material and the electrically-negative thermocouple material in the holes.

13. The thermopile of claim 7, further comprising a stencil configured to assist in depositing the electrically-positive thermocouple material and the electrically-negative thermocouple material.

14. The thermopile of claim 7, further comprising a negative lead and a positive lead each at an end of the electrically-serially connected thermocouple elements.

15. A method of creating a heat-resistant thermopile, comprising:
depositing an electrically-positive thermocouple material into a first set of holes in a heat-resistant, electrically-insulative container that contains cross-channels to a second set of holes parallel to the first set of holes;
depositing an electrically-negative thermocouple material into the second set of holes in the heat-resistant, electrically-insulative container; and
heating the heat-resistant, electrically-insulative container to sinter or melt the electrically-positive thermocouple material and the electrically-negative thermocouple material, wherein the cross-channels form hot junctions and cold junctions of thermocouple elements created by the electrically-positive thermocouple material and the electrically-negative thermocouple material.

16. The method of claim 15, wherein the electrically-negative thermocouple material and the electrically-positive thermocouple material are powders or pastes when deposited.

17. The method of claim 15, heating the heat-resistant, electrically-insulative container, the electrically-positive thermocouple material and the electrically-negative thermocouple material to over 500 degrees C. to create the heat-resistant thermopile.

18. A thermopile assembly having layers of ceramic substrates, comprising:
a first ceramic substrate and a second ceramic substrate, each having a sheet deposited of electrically-positive thermocouple material and electrically-negative thermocouple material to form a row of thermocouple elements, and an electrically-insulative material configured to create a space between the electrically-positive thermocouple material and the electrically-negative thermocouple material; and
a third ceramic substrate positioned between the first ceramic substrate and the second ceramic substrate and having a hole permitting contact between the thermocouple elements in the first and second ceramic substrates to form an electric series.

19. The thermopile assembly having layers of claim 18, further comprising:
a plurality of alternating layers of:
a fourth ceramic substrate having a second sheet deposited of electrically-positive thermocouple material and electrically-negative thermocouple material to form a second row of thermocouple elements, and an electrically-insulative material configured to create a space between the electrically-positive thermocouple material and electrically-negative thermocouple material; and
a fifth ceramic substrate positioned next to the fourth ceramic substrate having a hole permitting contact between thermocouple elements between substrates.

20. The thermopile assembly of claim 18, wherein the first, second, and third ceramic substrates, the electrically-positive thermocouple material, the electrically-negative thermocouple material, and the electrically-insulative material are 3D printed.
